(19) United States
(12) Patent Application Publication
(10) Pub. No.: US 2022/0072999 A1
(43) Pub. Date: Mar. 10, 2022

(54) METHOD AND APPARATUS FOR SIDE MIRROR AUTO ADJUST FOR TRAILERING IN A MOTOR VEHICLE

(71) Applicant: GM GLOBAL TECHNOLOGY OPERATIONS LLC, Detroit, MI (US)

(72) Inventors: Brian K. Saylor, South Lyon, MI (US); Matthew G. Kowal, Brighton, MI (US)

(73) Assignee: GM GLOBAL TECHNOLOGY OPERATIONS LLC, Detroit, MI (US)

(21) Appl. No.: 17/015,337

(22) Filed: Sep. 9, 2020

(51) Int. Cl. B60R 1/00; B60D 1/36; B60W 40/12; B60R 1/08; B60R 1/07

(52) U.S. Cl. CPC B60R 1/003; B60D 1/36; B60W 40/12; B60R 1/08; B60W 2554/802; B60K 2370/176; B60K 2370/179; B60W 2520/22; B60R 1/07

(57) ABSTRACT

Methods and apparatus are provided for articulating mirrors for trailering in a motor vehicle. The method includes receiving a trailer dimension, receiving an indication of a trailering mode, receiving an image of a trailer hitch assembly in response to the indication of the trailering mode, estimating a hitch articulation angle in response to the image, estimating a trailer rear corner position in response to the hitch articulation angle and the trailer dimension, generating a mirror control signal to adjust a mirror position such that the trailer rear corner position is within a mirror field of view, and adjusting the mirror position in response to the mirror control signal.

### INTRODUCTION

The present disclosure relates generally to a system of articulating trailer mirrors for use in a trailering application with a motor vehicle. More specifically, aspects of the present disclosure relate to systems, methods and devices for monitoring a trailer hitch articulation angle when operating a vehicle with attached trailer and for automatically articulating the vehicle mirrors such that the trailer remains visible within the mirror.

Pulling a trailer with a tow vehicle has always been and remains a complicated endeavor for many drivers. The ball hitch is typically employed as a trailer connection and provides a joint between the tow vehicle and the trailer. Aiming the trailer involves turning the rear of the tow vehicle in the opposite direction of the desired direction of the trailer. While the trailer movement is happening behind the tow vehicle, the driver must monitor the operation through the vehicle mirrors. As the trailer turns, the centerline of the trailer moves farther away from the centerline of the towing vehicle. When this happens, the driver can no longer see the rear of the trailer from the tow vehicle mirrors. Typically, a driver must rely on a second person to provide instructions to continue backing up, stop the tow vehicle and manually adjust the mirrors, or move the driver's head or body position to get a better view of the rear of the trailer. It would be desirable to provide a better trailer reversing option while overcoming the aforementioned problems.

The above information disclosed in this background section is only for enhancement of understanding of the background of the invention and therefore it may contain information that does not form the prior art that is already known in this country to a person of ordinary skill in the art.

### SUMMARY

Disclosed herein are vehicle braking methods and systems and related control logic for provisioning vehicle systems, methods for making and methods for operating such systems, and motor vehicles equipped with onboard control systems. By way of example, and not limitation, there is presented various embodiments of an automatically articulating mirror system for trailering in a motor vehicle, and a method for performing automatically articulating mirror system for trailering in a motor vehicle are disclosed herein.

In accordance with an aspect of the present disclosure, an apparatus including a trailer interface module for providing an indication of a trailing mode, a camera for capturing an image of a trailer hitch assembly in response to the indication of the trailering mode, a mirror controller configured to adjust a mirror position in response to a mirror control signal, an interface for receiving a trailer dimension, and a processor operative to determine a trailer hitch articulation angle in response to the image, to calculate a trailer rear corner position in response to the trailer hitch articulation angle and the trailer dimension, and for generating a mirror control signal to adjust the mirror position such that the trailer rear corner position is within a mirror field of view.

In accordance with an aspect of the present disclosure the mirror position is adjusted from a user defined initial mirror position.

In accordance with an aspect of the present disclosure the trailer dimension is received via the interface in response to a user input.

In accordance with an aspect of the present disclosure the trailer dimension is received via the interface in response to a trailer dimension detecting algorithm.

In accordance with an aspect of the present disclosure the trailer dimension is determined in response to a first image of the trailer and a second image of the trailer.

In accordance with an aspect of the present disclosure the trailer dimension is determined in response to a first user defined mirror position and a second user defined mirror position.

In accordance with an aspect of the present disclosure the mirror controller is operative to adjust the mirror position of a driver's side mirror in response to the trailer hitch articulation angle being indicative of a trailer being angled towards a left side of a towing vehicle.

In accordance with an aspect of the present disclosure the mirror control signal is generated in response to the trailer hitch articulation angle exceeding a threshold angle and wherein the threshold angle is indicative of the trailer rear corner position being at an outside edge of an initial mirror field of view.

In accordance with another aspect of the present disclosure, a method including receiving a trailer dimension, receiving an indication of a trailering mode, receiving an image of a trailer hitch assembly in response to the indication of the trailering mode. estimating a hitch articulation angle in response to the image, estimating a trailer rear corner position in response to the hitch articulation angle and the trailer dimension, generating a mirror control signal to adjust a mirror position such that the trailer rear corner position is within a mirror field of view, and adjusting the mirror position in response to the mirror control signal.

In accordance with an aspect of the present disclosure the mirror position is adjusted from a user defined initial mirror position.

In accordance with an aspect of the present disclosure the trailer dimension is received via a user input.

In accordance with an aspect of the present disclosure the trailer dimension is received via a trailer dimension detecting algorithm.

In accordance with an aspect of the present disclosure the trailer dimension is determined by a trailer dimension detecting algorithm in response to a first image of the trailer and a second image of the trailer.

In accordance with an aspect of the present disclosure the trailer dimension is determined in response to a first user defined mirror position and a second user defined mirror position.

In accordance with an aspect of the present disclosure including adjusting a mirror position of a driver's side mirror in response to the hitch articulation angle being indicative of a trailer being angled towards a left side of a towing vehicle.

In accordance with an aspect of the present disclosure the mirror control signal is generated in response to the hitch articulation angle exceeding a threshold angle and wherein the threshold angle is indicative of the trailer rear corner position being at an outside edge of an initial mirror field of view.

In accordance with another aspect of the present disclosure, a vehicular mirror control system including a trailer interface operative to detect a trailer connection, a camera configured for capturing an image of a trailer hitch assembly in response to the detection of the trailer connection, a user input configured to receive a trailer dimension, a mirror motor operative to position a vehicle mirror in response to a mirror control signal, a processor operative to determine a hitch articulation angle in response to the image of the trailer hitch assembly, to estimate a trailer rear corner position in response to the hitch articulation angle and the trailer dimension and to generate the mirror control signal in response to the trailer rear corner position and a tow vehicle dimension.

In accordance with an aspect of the present disclosure the tow vehicle dimension is a distance between the vehicle mirror and the trailer hitch assembly.

In accordance with an aspect of the present disclosure the hitch articulation angle is determined by comparing the image of the trailer hitch assembly to a prior image of the trailer hitch assembly captured during an alignment of a vehicle centerline and a trailer centerline.

In accordance with an aspect of the present disclosure the hitch articulation angle is determined by performing an edge detection algorithm on the image of the trailer hitch assembly.

The above advantage and other advantages and features of the present disclosure will be apparent from the following detailed description of the preferred embodiments when taken in connection with the accompanying drawings.

### BRIEF DESCRIPTION OF THE DRAWINGS

The exemplary embodiments will hereinafter be described in conjunction with the following drawing figures, wherein like numerals denote like elements, and wherein:

FIG. 1 shows an application for the method and apparatus for articulating mirrors for trailering in a motor vehicle according to an exemplary embodiment of the present disclosure.

FIG. 2 shows a block diagram illustrating a system for articulating mirrors for trailering in a motor vehicle according to an exemplary embodiment of the present disclosure; and

FIG. 3 shows a flow chart illustrating a method for articulating mirrors for trailering in a motor vehicle according to an exemplary embodiment of the present disclosure.

FIG. 4 shows a block diagram illustrating a system for articulating mirrors for trailering in a motor vehicle according to another exemplary embodiment of the present disclosure; and

FIG. 5 shows a flow chart illustrating a method for articulating mirrors for trailering in a motor vehicle according to another exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

The present application discloses a system of outside rearview mirrors which automatically move in response to the position of an attached trailer. The mirrors automatically adjust to maintain visibility of portions the trailer in a common area of the mirror. The method and system teach that the side mirrors are linked to a system to detect the position and orientation of an attached trailer and determine the necessary mirror adjustment to maintain visibility and to automatically adjust the mirrors in response to the detection. In an exemplary embodiment, the towing vehicle's power mirrors automatically adjust to show a trailer's rear corner in a common mirror location as the trailer articulates relative to the towing vehicle. The driver mirror is active when the trailer is articulated to the left and the passenger mirror when the trailer is articulated to the right. The system may be operative in both reversing the tow vehicle with an attached trailer or driving forward with the tow vehicle for monitoring trailer position during turns, such as around corners and lane positioning.

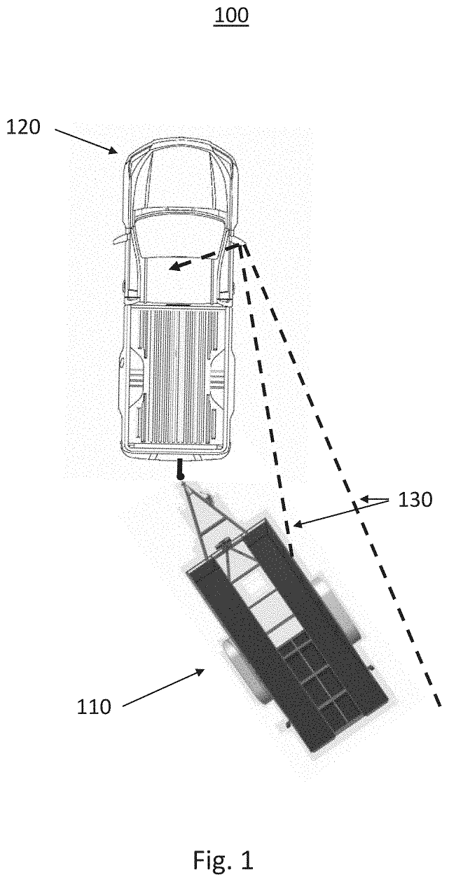

Turning now to FIG. 1, an exemplary application for articulating mirrors for trailering in a motor vehicle 100 according to an exemplary embodiment of the present disclosure is shown. The exemplary application shows a towing vehicle 120 and a trailer 110. The field of view 130 of the driver using the passenger side mirror is also illustrated. According to the exemplary embodiment, the passenger side mirror has been adjusted such that the rear corner of the trailer is within the field of view 130. If the mirror was not adjusted, the driver's field of view would be along the passenger side of the towing vehicle towards the rear, and the mirror would show the front corner of the trailer 110.

A problem exists in that current side rear-view mirrors can be difficult to use while backing up a trailer due to their limited viewing angle. Side mirrors are typically set-and forget positions set by a driver for forward driving. In addition, driving forward with a trailer around tight corners also risks the trailer contacting curbs, bollards, poles, mailboxes. The exemplary system is operative to estimate a trailer position in response to an angle of the hitch assembly and is operative to actively modify the side mirror positions in order to optimize the field of view for the trailer as the vehicle and trailer combination is maneuvered around corners. In one example, the exemplary system may only adjust the necessary mirror based upon the direction of turn and trailer and the total angle of articulation. In another example the exemplary system may further monitor a vehicle steering wheel position and displacement in order to adjust the outside mirrors to the known location of the trailer extremes.

In an exemplary embodiment, a system performing a mirror articulating algorithm is operative to first receive trailer dimension information from a vehicle operator or from a separate algorithm, such as a method for automatically estimating a trailer dimension in response to image data. The system is then operative to determine a trailer articulation angle which is the angle between the trailer centerline and the towing vehicle centerline. The system may determine the trailer articulation angle in response to an image captured of the hitch assembly or may be estimated in response to pressure sensors within the towing vehicle hitch assembly. In addition, the steering angle of the towing vehicle may be used to estimate the trailer articulation angle. The system is then operative to estimate a trailer rear corner location in response to the hitch articulation angle and the trailer dimensions and to adjust the mirror accordingly such that the rear corner of the trailer is within the field of view of the mirror. The system may further allow a vehicle operator to adjust the mirror angle to compensate for seat position and/or driver position. This adjustment value may then be considered for future mirror adjustment positioning operations.

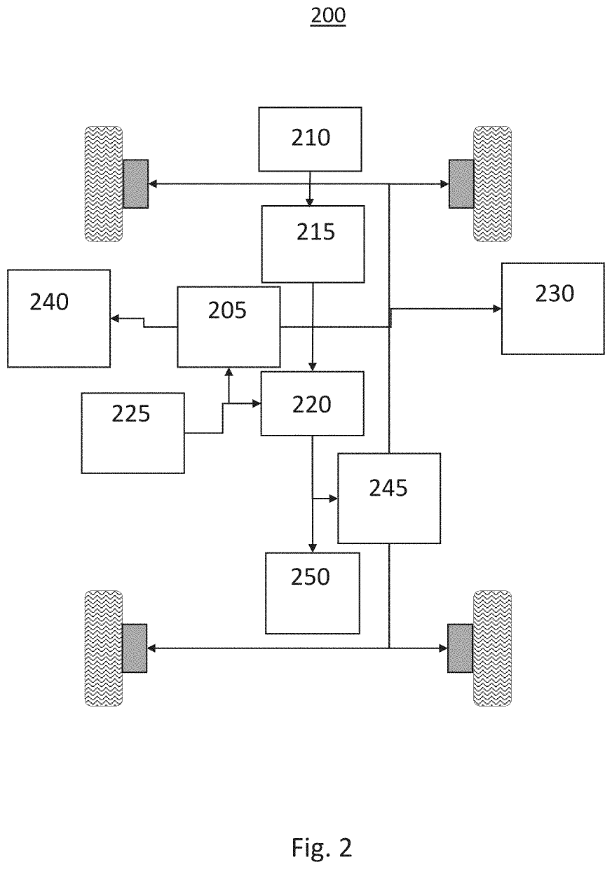

Turning now to FIG. 2, a block diagram of an exemplary system for articulating mirrors for trailering in a motor vehicle 200 according to an exemplary embodiment of the present disclosure is shown. The system 200 includes a driver's side mirror 240, a passenger side mirror 230, a processor 220, a user interface 225, a vehicle controller 245, a trailer interface module 250, a camera 210, and a mirror control system 205.

The mirror control system 205 is operative to receive control signals from a user interface to adjust the angles of the driver's side mirror 240 and the passenger side mirror 230. These control signals are typically generated in response to a driver input as the driver sits in the driver's seat and adjusts the angle of the mirrors for the desired rear view. Motors in the housing of the driver's side mirror 240 and the housing of the passenger side mirror 230 are operative to angle their respective mirrors in both horizontal and vertical directions in response to the control signals. In one exemplary embodiment, the driver's setting on the mirrors will be a default or origin setting for the mirror adjustment algorithm. For example, all automatic mirror adjustments in response to the mirror adjustment algorithm may be made with reference to the default position set by the driver.

In this exemplary embodiment, the trailer interface module 250 may be operative to control the lighting and braking of a trailer in response to control signals from the vehicle controller 245 and the processor 220. The trailer interface module 250 may also be operative to generate an indication of an attached trailer. This may be done in response to an impedance measurement on the trailer electrical connector, a deflection measurement on the trailer hitch, or in response to the vehicle being placed into a towing mode.

The camera 210 may be a rear-view camera with a field of view that includes the hitch assembly. The camera 210 may be operative to capture an image of the field of view including the hitch assembly and couple this image to the processor 220. Alternatively, the camera 210 may be a wide angle aspect camera mounted to the rear of the vehicle such that the sides of a trailer could be seen during reverse towing operations. Alternatively, or in addition, the camera 210 may be one of a plurality of cameras mounted on each side view mirror. The camera 210 may then have a wide angle view from the side mirror viewpoint. The camera 210 may transmit an image or series of images to the processor 220 or to a video controller 215 for processing the images and coupling this signal to the processor 220.

The processor 220 is operative to control the method for articulating mirrors for trailering in a motor vehicle. The processor 220 may receive data from the trailer interface module 250, the vehicle controller 245, the camera 210, the user interface 225 and/or the video processor 215. The processor 220 may operative to receive vehicle information, such as wheelbase and driver position and trailer information, such as trailer wheelbase, trailer dimensions, trailer track, trailer articulation angle, etc. via the user interface 225 or may receive the vehicle information from a memory, vehicle controller or via a trailer dimensional algorithm or the like. In one exemplary embodiment, images and/or video from the camera 210 may be used to estimate one or more trailer dimensions prior to and/or during connection of the trailer to the tow vehicle. The processor 220 may further be operative to determine the hitch articulation angle in response to images received from the camera 210. For example, the processor 320 may generate a model of a hitch assembly when the vehicle is traveling in a straight forward direction using image detection techniques on the images, such as edge detection or the like. These image detection techniques may be performed on a series of images and the cumulative results are used to generate the model of the trailer hitch assembly. Furthermore, the processor 220 may be operative to estimate a trailer centerline with respect to the trailer hitch assembly as part of the model.

In an exemplary embodiment, the processor 220 is operative to monitor the steering position and the longitudinal velocity of the vehicle through the vehicle controller 245. The system is further operative to monitor the trailer interface module 250 to determine if a trailer is being towed. If the trailer is being towed, the processor 220 is operative to estimate the trailer angle in response to the trailer dimensions, the steering and velocity, the hitch articulation angle, and/or the hitch assembly model and to generate a mirror control signal to couple to the mirror control system 205. The mirror control system 205 is operative to adjust the appropriate mirror, either passenger side mirror 230 or driver's side mirror 240, in response to the mirror control signal. The mirror control system 205 may estimate mirror articulation geometry based on a control algorithm or the like.

In another exemplary embodiment, the processor 220 is operative to use image recognition techniques in order to determine the angle of a towed trailer. For example, if the trailer interface module 250 indicates that a trailer is being towed. The processor 220 is then operative to receive an image of the trailer hitch assembly from the video controller 215. The processor 220 may estimate the hitch articulation angle in response to image processing techniques performed on the image. Once the processor 220 determines the hitch articulation angle, the processor then estimates the location and orientation of the trailer in response to the vehicle and trailer dimensions and then generates a mirror control signal to couple to the mirror control system 205. The mirror control system 205 is then operative to adjust the appropriate mirror, either passenger side mirror 230 or driver's side mirror 240, in response to the mirror control signal.

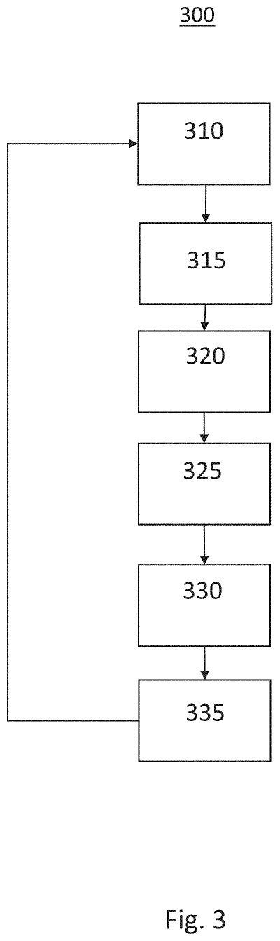

Turning now to FIG. 3, a flow chart illustrating an exemplary method for articulating mirrors for trailering in a motor vehicle 300 according to an exemplary embodiment of the present disclosure is shown. In this exemplary embodiment the method is first operative to receive at 310 an indication of a towing operation. Examples of this indication may include the towing vehicle being placed into a tow mode via a user interface, an indicator from a trailer interface module indicating the connection of a trailer, or a change in voltage or capacitance on a trailer electrical connector indicating a trailer electrical system has been connected. The user interface may include a button within the vehicle compartment or may be selected through an option on a visual user interface on an infotainment system. The trailer interface module may determine the presence of a trailer in response to an electrical connector being connected or through a deflection of a trailer hitch or in response to a longitudinal force on the trailer hitch.

In this exemplary embodiment, once the towing operation mode has been established, the method is then operative to receive an image from a rear facing camera at 315. The rear facing camera may be a wide angle camera mounted on the rear of the vehicle or may be a camera mounted onto a side view mirror of the vehicle. The image may be a single image or a frame of a video stream. The image may be a composite rear view image generated by combining, or stitching, an image take from a driver's side mirror camera and an image taken from a passenger side mirror camera. This composite image may simultaneously display the trailer hitch assembly and both sides of the trailer.

The method is next operative to determine at 320 a hitch angle in response to the image. The hitch angle may be determined in response to a comparison of an image captured of the hitch assembly during a straight travel situation wherein the trailer centerline angle is the same as the towing vehicle centerline angle. The method is then operative to compare the straight travel hitch assembly image to the currently received image and determine an angular difference in response to the comparison. For example, using edge detection techniques on the two images, a hitch angle of 5° may be determined in response to the angular rotation of the hitch assemble.

In response to the determination of the hitch angle, the method may then be operative to calculate a mirror angle at 325 in response to the hitch angle, the physical dimensions of the towing vehicle and the physical dimensions of the trailer. The physical dimension of the trailer may be determined in response to a user input, wherein a user may enter the physical dimensions directly into a user input, or may select a general size and share of a trailer, such as a small utility trailer, flatbed car trailer or a fifth wheel camper trailer. Alternatively, the trailer dimensions may be estimated by a trailer dimension estimating algorithm in response to one or more images captured by one or more cameras. In an exemplary embodiment, trailer dimensions may include tow hitch ball to center of trailer wheels, tow hitch ball to rear of trailer, overall trailer length, overall trailer width, etc. Towing vehicle dimensions may include distance of mirror to towing vehicle centerline and distance of mirror to tow hitch ball.

The method is then operative to generate a control signal at 330 to adjust the mirror in response to the hitch articulation angle and dimensions of the trailer. Additional factors for generating the control signal may be velocity and/or angle of steering of the towing vehicle. In an exemplary embodiment, the method may be operative to determine the current angle of the mirror as a baseline for the driver view. In one exemplary embodiment, the method is operative to center a rear corner of the trailer on the center of the field of view of the mirror. A control signal may then be generated at 330 to adjust the mirror from the baseline an amount that would compensate for the deviation of the trailer. For example, if the deviation between the centerline of the trailer and the centerline of the tow vehicle is 45 degrees to the passenger side, it may be determined that the passenger side mirror must angle out 7 additional degrees in order for the driver to see the rear edge of the trailer and/or the trailer wheels. The control signal is then indicative of a 7-degree adjustment from the current baseline position. The control signal may then be coupled to a mirror control system or directly to the appropriate mirror for adjustment at 335 in response to the control signal.

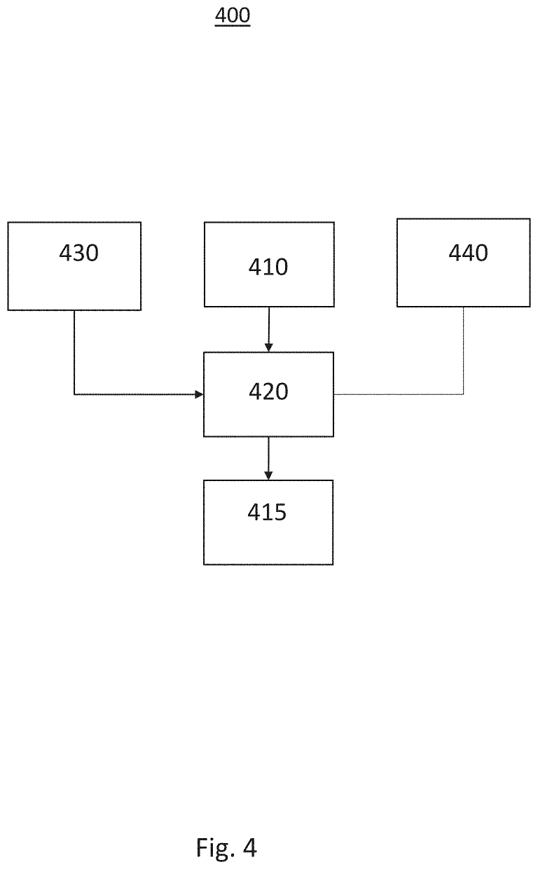

Turning now to FIG. 4, a block diagram of a system 400 for articulating mirrors for trailering in a motor vehicle according to an exemplary embodiment of the present disclosure is shown. A vehicular mirror control system includes a trailer interface module 410, a camera 430, a data interface 440 and a processor 420 and a mirror controller 450.

In an exemplary embodiment, the system 400 may include a trailer interface module 410 for providing an indication of a trailing mode. The trailer interface module 410 may be operative for coupling data and/or control signals between a towing vehicle and the trailer, such as brake and indicator light settings, brake control commands, coupling of video or image data, and the like. The trailer interface module 410 may further be operative for detecting the connection of a trailer to the towing vehicle in response to a change in impedance or voltage of a trailer interface module 410 connector. For example, connection of a trailer plug to a vehicle trailer connector may provide an indication that a trailer has been connected and that a trailering mode should be entered by the towing vehicle.

The exemplary system 400 may further include a camera 430 for capturing an image of a trailer hitch assembly in response to the indication of the trailering mode. The camera 430 may be mounted on the rear of a vehicle to monitor the trailer hitch assembly. For example, the camera 430 may be a reverse camera mounted to the rear of a vehicle, mounted to a tailgate of a pickup truck, or may be mounted to a truck cab for monitoring a bed mounted trailer hitch, such as a 5^{th} wheel hitch.

The exemplary system 400 may further include a mirror controller 450 configured to adjust a mirror position in response to a mirror control signal. In an exemplary embodiment, the mirror controller 450 may be operative to adjust the mirror position of a driver's side mirror in response to the trailer hitch articulation angle being indicative of a trailer being angled towards a left side of a towing vehicle.

The exemplary system 400 may further include an interface 440 for receiving a trailer dimension. In one exemplary embodiment, the interface 440 may be a user interface wherein the trailer dimension is received via the interface in response to a user input. Alternatively, the interface may be a connection to a vehicle controller or the like for performing a trailer dimension detecting algorithm and wherein the trailer dimension is received via the interface in response to a trailer dimension detecting algorithm. In this example, wherein the trailer dimension may be estimated in response to a first image of the trailer and a second image of the trailer. For example, a travel trailer is typically around eight feet wide and ten- and one-half feed wide. In this example, the trailer dimension detecting algorithm may compare the images and estimate a length of the trailer in response to these two estimated dimensions. Alternatively, the trailer dimension may be determined in response to a first user defined mirror position and a second user defined mirror position For example, the system 400 may be operative to perform an algorithm wherein a vehicle operator adjusts a mirror to view a back corner of the trailer when the trailer is at a known articulation angle. In response to the adjusted mirror position, the system 400 may be operative to estimate a trailer length and thereby adjust a mirror dynamically during trailering operations using the estimated trailer length. A vehicle operator may be provided an opportunity to adjust the mirrors to refine the estimated length during towing operations.

The exemplary system 400 may further include a processor 420 operative to determine a trailer hitch articulation angle in response to the image, to calculate a trailer rear corner position in response to the trailer hitch articulation angle and the trailer dimension, and for generating a mirror control signal to adjust the mirror position such that the trailer rear corner position is within a mirror field of view. In one exemplary embodiment, the mirror control signal may be generated in response to the trailer hitch articulation angle exceeding a threshold angle and wherein the threshold angle is indicative of the trailer rear corner position being at an outside edge of an initial mirror field of view. For example, the mirror control signal may not result in the mirror continuously moving with the rear of the trailer, but only being repositioned when the rear corner of the trailer approaches the edge of the field of view of the mirror. In an exemplary embodiment, the mirror position may be adjusted from a user defined initial mirror position. The user defined initial mirror position may be set by the user during normal non-trailing operation of the vehicle wherein the driver adjusts the mirror for the driver's particular body dimensions, seating position and driver's seat settings.

In accordance with another aspect of the present disclosure, a vehicular mirror control system including a trailer interface operative to detect a trailer connection, a camera configured for capturing an image of a trailer hitch assembly in response to the detection of the trailer connection, a user input configured to receive a trailer dimension, a mirror motor operative to position a vehicle mirror in response to a mirror control signal, a processor operative to determine a hitch articulation angle in response to the image of the trailer hitch assembly, to estimate a trailer rear corner position in response to the hitch articulation angle and the trailer dimension and to generate the mirror control signal in response to the trailer rear corner position and a tow vehicle dimension. For example, the tow vehicle dimension may a distance between the vehicle mirror and the trailer hitch assembly. In addition, the hitch articulation angle may be determined by comparing the image of the trailer hitch assembly to a prior image of the trailer hitch assembly captured during an alignment of a vehicle centerline and a trailer centerline. For example, the hitch articulation angle may be determined by performing an edge detection algorithm, such as a Canny edge detection algorithm, on the image of the trailer hitch assembly

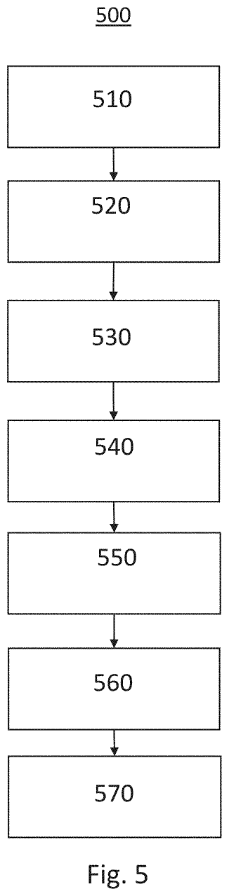

Turning now to FIG. 5, a flow chart illustrating another exemplary method for articulating mirrors for trailering in a motor vehicle 500 according to an exemplary embodiment of the present disclosure is shown. The method is first operative to receiving 510 a trailer dimension. The trailer dimension may be received via a user input, a trailer dimensioning algorithm or via a data from the trailer. For example, the trailer may include a memory for storing trailer dimensions and is operative to transfer the trailer dimensions to a vehicle processor via a trailer interface module.

The method is next operative for receiving 520 an indication of a trailering mode. The trailering mode may be indicated in response to a user selection of trailing mode at a user interface with the towing vehicle such as a tow mode button for shifting a vehicle propulsion controller into a tow mode. Alternatively, the tow mode may be indicated by an electrical connection to a trailer connector. The tow mode may be indicated by a pressure or deflection sensor on a tow hitch of the towing vehicle.

The method is next operative for receiving 530 an image of a trailer hitch assembly in response to the indication of the trailering mode. The image may be received via a rear view camera. The method is then operative for estimating 540 a hitch articulation angle in response to the image. The hitch articulation angle may be estimated using edge detection techniques for detecting linear elements of the travel hitch and the trailer body. The method is next operative for estimating 550 a trailer rear corner position in response to the hitch articulation angle and the trailer dimension. For example, the rear corner position may be estimated in response to a trailer length and the hitch articulation angle. The trailer rear corner position may be estimated relative to a towing vehicle position or the like or may be estimated in response to a towing vehicle location received via a global positioning system, a vehicle dimension, such as a dimension between global positioning system sensor and the trailer hitch, the trailer length, and the hitch articulation angle

The method is next operative for generating 560 a mirror control signal to adjust a mirror position such that the trailer rear corner position is within a mirror field of view in response to the mirror control signal. In one exemplary embodiment, the mirror position is adjusted from a user defined initial mirror position. In another exemplary embodiment, adjusting a mirror position of a driver's side mirror may be made response to the hitch articulation angle being indicative of a trailer being angled towards a left side of a towing vehicle. On addition, the mirror control signal is generated in response to the hitch articulation angle exceeding a threshold angle and wherein the threshold angle is indicative of the trailer rear corner position being at an outside edge of an initial mirror field of view.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a trailer interface module configured for providing an indication of a trailing mode;
a camera configured for capturing an image of a trailer hitch assembly in response to the indication of the trailering mode;
a mirror controller configured to adjust a mirror position in response to a mirror control signal;
an interface for receiving a trailer dimension; and
a processor operative to determine a trailer hitch articulation angle in response to the image, to calculate a trailer rear corner position in response to the trailer hitch articulation angle and the trailer dimension, and for generating a mirror control signal to adjust the mirror position such that the trailer rear corner position is within a mirror field of view.

2. The apparatus of claim 1 wherein the mirror position is adjusted from a user defined initial mirror position.

3. The apparatus of claim 1 wherein the trailer dimension is received via the interface in response to a user input.

4. The apparatus of claim 1 wherein the trailer dimension is received via the interface in response to a trailer dimension detecting algorithm.

5. The apparatus of claim 1 wherein the trailer dimension is determined in response to a first image of the trailer and a second image of the trailer.

6. The apparatus of claim 1 wherein the trailer dimension is determined in response to a first user defined mirror position and a second user defined mirror position.

7. The apparatus of claim 1 wherein the mirror controller is operative to adjust the mirror position of a driver's side mirror in response to the trailer hitch articulation angle being indicative of a trailer being angled towards a left side of a towing vehicle.

8. The apparatus of claim 1 wherein the mirror control signal is generated in response to the trailer hitch articulation angle exceeding a threshold angle and wherein the threshold angle is indicative of the trailer rear corner position being at an outside edge of an initial mirror field of view.

9. A method comprising:
receiving a trailer dimension;
receiving an indication of a trailering mode;
receiving an image of a trailer hitch assembly in response to the indication of the trailering mode;
estimating a hitch articulation angle in response to the image;
estimating a trailer rear corner position in response to the hitch articulation angle and the trailer dimension;
generating a mirror control signal to adjust a mirror position such that the trailer rear corner position is within a mirror field of view; and
adjusting the mirror position in response to the mirror control signal.

10. The method of claim 9 wherein the mirror position is adjusted from a user defined initial mirror position.

11. The method of claim 9 wherein the trailer dimension is received via a user input.

12. The method of claim 9 wherein the trailer dimension is received via a trailer dimension detecting algorithm.

13. The method of claim 9 wherein the trailer dimension is determined by a trailer dimension detecting algorithm in response to a first image of the trailer and a second image of the trailer.

14. The method of claim 9 wherein the trailer dimension is determined in response to a first user defined mirror position and a second user defined mirror position.

15. The method of claim 9 including adjusting a mirror position of a driver's side mirror in response to the hitch articulation angle being indicative of a trailer being angled towards a left side of a towing vehicle.

16. The method of claim 9 wherein the mirror control signal is generated in response to the hitch articulation angle exceeding a threshold angle and wherein the threshold angle is indicative of the trailer rear corner position being at an outside edge of an initial mirror field of view.

17. A vehicular mirror control system comprising:
a trailer interface operative to detect a trailer connection;
a camera configured for capturing an image of a trailer hitch assembly in response to the detection of the trailer connection;
a user input configured to receive a trailer dimension;
a mirror motor operative to position a vehicle mirror in response to a mirror control signal; and
a processor operative to determine a hitch articulation angle in response to the image of the trailer hitch assembly, to estimate a trailer rear corner position in response to the hitch articulation angle and the trailer dimension and to generate the mirror control signal in response to the trailer rear corner position and a tow vehicle dimension.

18. The vehicular mirror control system of claim 17 wherein the tow vehicle dimension comprises a distance between the vehicle mirror and the trailer hitch assembly.

19. The vehicular mirror control system of claim 17 wherein the hitch articulation angle is determined by comparing the image of the trailer hitch assembly to a prior image of the trailer hitch assembly captured during an alignment of a vehicle centerline and a trailer centerline.

20. The vehicular mirror control system of claim 17 wherein the hitch articulation angle is determined by performing an edge detection algorithm on the image of the trailer hitch assembly.
